(19) United States
(12) Patent Application Publication
(10) Pub. No.: US 2014/0190050 A1
(43) Pub. Date: Jul. 10, 2014

(54) Duplex Printed Package Assembly Documents

(71) Applicant: Premier Print & Service Group, Inc., Chicago, IL (US)

(72) Inventor: Bruce Raming, Northbrook, IL (US)

(73) Assignee: Premier Print & Service Group, Inc., Chicago, IL (US)

(21) Appl. No.: 14/148,207

(22) Filed: Jan. 6, 2014

Related U.S. Application Data
(60) Provisional application No. 61/748,925, filed on Jan. 4, 2013.

(51) Int. Cl. G09F 3/00; G07B 17/00

(52) U.S. Cl. CPC G09F 3/0289; G07B 17/00508
USPC 40/630; 427/256

(57) ABSTRACT

A package assembly document comprises a top ply and a bottom ply. The top ply has a first shipping label and a first return label. The bottom ply has a top surface and a bottom surface. The top surface comprises silicone and is configured for releasable attachment of each of the first shipping label and the first return label. The bottom surface has indicia printed thereon. The indicia contains a list outlining contents of a package to which the first shipping label is to be adhered to. The top ply includes a slit to separate the first shipping label from the first return label.

### CROSS-REFERENCE TO RELATED APPLICATIONS

This Application claims priority to U.S. Provisional Application, Ser. No. 61/748,925, filed Jan. 4, 2013, the disclosure of which is incorporated herein by reference in its entirety.

### BACKGROUND

1. Field

The present invention relates generally to a label system. More specifically, embodiments of the present invention concern a label with top side parcel shipping indicia or data in sections and bottom side packing slip indicia or data.

2. Discussion of Prior Art

Numerous types of business forms are adhesively attached to a substrate or box such as a shipping container. For instance, packing and shipping labels are often adhered directly to a box, envelope, container or other packaging for shipping a product. Conventional shipping labels and packing lists are provided as separate documents for each shipping package in two data streams to the warehouse distribution center with a 4×6 thermal shipping label and an 8.5×11 laser packing slip. Fold under labels with pattern adhesive require the packing slip to fold under the shipping label and the label is then adhered to the outside of the box, with the shipping information showing. Combination duplex shipping labels and packing slips are all in one document that are made with the packing slip underneath the shipping label (without folding) and affixed to the outside of the box. Part form and part label combinations require the shipping label to be removed by hand and the balance of the document dropped inside the box or put inside a PACKING SLIP ENCLOSED plastic pouch. One thing all of these present day systems have in common is the desire to have the packing slip kept confidential.

Conventional business forms for shipping labels and packing slips suffer from various undesirable limitations. First, for example, two data streams for separate documents often yields mismatches in shipping labels and packing slips. Second, fold under labels are typically close to 13 or 14 inches of material long and only use one side of the label for variable data, wasting lots of costly pressure sensitive material with pattern adhesive. Third, duplex adhesive shipping labels are deficient because they involve the use of label stock, an adhesive pattern on the label stock, and a liner that covers the adhesive pattern when both sides of the duplex labels are printed. When the duplex printed label is ready to be applied to a substrate, a portion of the liner is typically removed from the label stock to expose the adhesive and the removed portion of the liner is typically discarded as waste. Finally, part form and part label combinations suffer from uneven thicknesses causing feed problems and jams. There is also a lot of wasted material on part form and part label combinations.

### SUMMARY

The following brief summary is provided to indicate the nature of the subject matter disclosed herein. While certain aspects of the present invention are described below, the summary is not intended to limit the scope of the present invention.

Embodiments of the present invention provide a two ply label system that does not suffer from the problems and limitations of the prior art labels set forth above.

A first aspect of the present invention concerns a parcel shipping side with both an outbound (or shipping) label and an inbound (or return) label, and a second or back side for a packing list. The parcel label side is separated by a slit or gap between the outbound and return parcel labels. The shipping label is operable to be applied to an outbound package by permanent pressure sensitive material. The return label is operable to be applied to a return package by permanent pressure sensitive material. The packing list is operable to define what stock keeping units (“SKUs”) are in the box or shipping container.

A second aspect of the present invention concerns label media that could be supplied as individual sheets or fanfolded documents or supplied in rolls. This label media is designed for two sided variable indicia on both sides of the media. This media is also flat in nature.

A third aspect of the present invention concerns a package assembly system to be shipped to a recipient and possibly returned to the sender. The labeled package assembly broadly includes a package and a two ply combination label media with parcel shipping labels on the top ply and a packing slip on the bottom ply. The package contains at least one item or SKU to be received by the recipient. The combination label has an outbound shipping label that is affixed in an unfolded condition.

A fourth aspect of the present invention is optional press printed or static printed information on the silicone side or liner ply. Terms and Conditions, how to return item(s), or websites and phone numbers, et cetera, could be printed in this valuable area. This option saves precious and costly media.

Other aspects and advantages of the present invention will be apparent from the following detailed description of the embodiments and the accompanying drawing figures.

### BRIEF DESCRIPTION OF THE DRAWING FIGURES

Preferred embodiments of the invention are described in detail below with reference to the attached drawing figures, wherein:

FIGS. 1A through 1D show various types of two sided printers and printable documents.

FIGS. 2A and 2B respectively show a two ply face ply (top ply) and liner ply (bottom ply) of a pressure sensitive label for a Package Assembly Document, in line with the teachings of the present invention.

FIGS. 3A and 3B respectively show variable parcel shipping indicia on the top ply and variable package contents (packing slip) on the bottom ply.

FIGS. 4A through 4B show portions of the top ply shipping label being removed and static indicia that was press printed on a silicone side of the bottom ply liner exposed.

FIG. 5 shows a portion of the Package Assembly Document that is dropped into an open box with box contents.

FIG. 6 shows an outbound parcel shipping pressure sensitive label affixed to a box ready for shipping.

FIGS. 7A through 7B show a recipient's portions of the Package Assembly Document.

FIG. 7C shows a return label affixed to the box for return of goods.

FIGS. 8A through 8C show multiple sizes for another embodiment of the Package Assembly Document of FIGS. 2A-2B with a plurality of outbound and inbound parcel shipping label combinations for a specific order.

FIGS. 9A through 9C show multiple sizes for another embodiment of the Package Assembly Document of FIGS. 2A-2B with a plurality of outbound parcel shipping label combinations for a specific order.

FIG. 10A shows another embodiment of the Package Assembly Document of FIGS. 2A-2B.

FIG. 10B shows yet another embodiment of the Package Assembly Document of FIGS. 2A-2B.

The drawing figures do not limit the present invention to the specific embodiments disclosed and described herein. The drawings are not necessarily to scale, emphasis instead being placed upon clearly illustrating the principles of the preferred embodiment.

### DETAILED DESCRIPTION

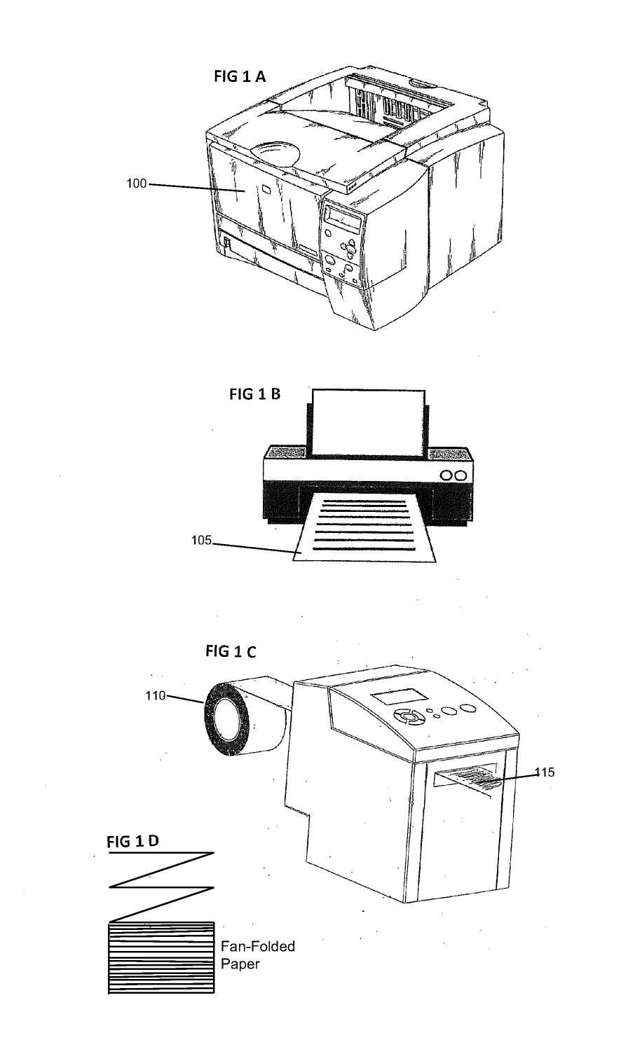

The first embodiment of the present invention is summarized in FIGS. 1 to 7. The package assembly system includes a media supply which may be permanent pressure sensitive material, a duplex printer, and a box. Variable parcel label data may be printed on one side of the document and variable packing slip data may be printed on the back or reverse side of the document corresponding to box contents.

Turning initially to FIG. 1A, a duplex laser printer is shown. A Package Assembly Document may be located inside a printer tray 100. Duplex imaged documents are not shown in this figure.

FIG. 1B shows what might be an ink jet printer with separate or individual documents and the documents variably printed. Indicia 105 are shown printed on the top side of the document in FIG. 1B. The bottom side or packing slip variable indicia is not shown.

FIG. 1C is a roll fed duplex thermal printer. One example of a duplex thermal printer is FOX IV Technologies' TwinPrint thermal printer. Other manufacturers such as SATO (model GY412) and TOSHIBA make similar units. The SATO unit is now offered with and without a cutter to separate the roll into individual pressure sensitive labels. Thermal printers may be direct thermal, wherein no ribbon is needed, or thermal transfer, where a ribbon is needed. Either a direct thermal or thermal transfer thermal printer may be acceptable. In the roll fed duplex thermal printer as shown in FIG. 1C, the roll 110 is fed into the thermal printer and indicia may be printed on one or both sides of the labels. In FIG. 1C, indicia 115 printed on the top side of the label is shown. The bottom side or packing slip variable indicia is not shown. The roll may have a perforation between labels for hand separation. FIG. 1D is a hand drawn fanfolded stack of Package Assembly Documents connected together by a perforation in the liner between labels and this stack of documents would feed into the printer very much like the roll in FIG. 1C. The label supply could be singles, roll or fanfold. FIG. 1C could have a tear bar to separate the labels by hand, not shown.

The top indicia are preferably printed by a laser or thermal printer. The bottom indicia are preferably printed by a laser or thermal printer. It is most common for the technologies to be the same in one printer, although this is not necessary. For example, top laser and bottom laser or top thermal and bottom thermal printers may be employed for the printing. A mix of technologies may also be employed such as top side direct thermal and bottom side thermal transfer, or top side ink jet and bottom side direct thermal. Hence, a mix of technologies could be used to variably print indicia on the two sides of the Package Assembly Document.

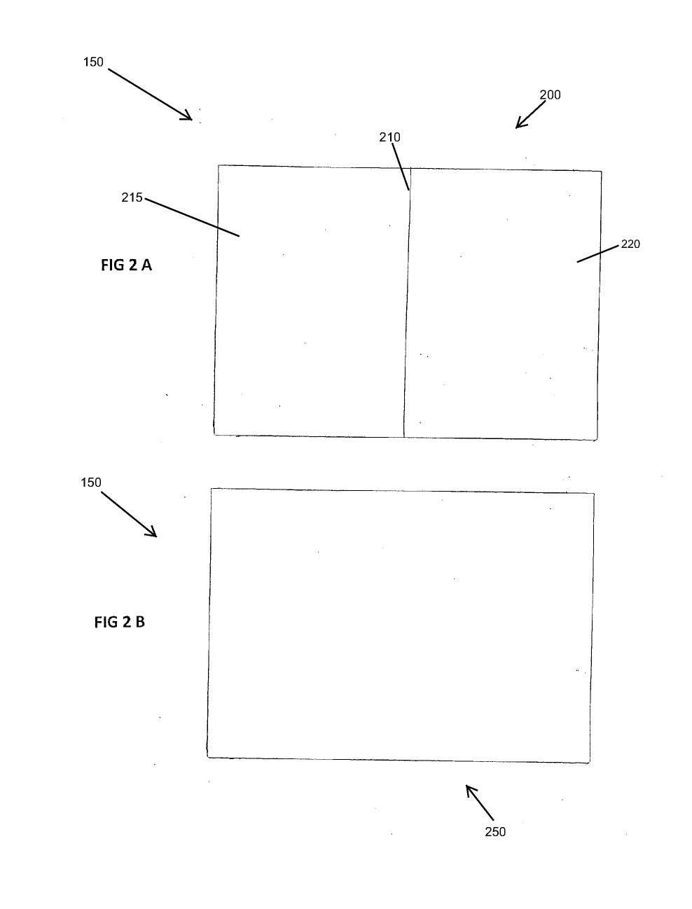

Turning now to FIGS. 2A-2B, a package assembly label (or document) 150 is shown. The construction is two ply: a face ply (top ply) 200 as shown in FIG. 2A and a liner ply (bottom ply) 250 as shown in FIG. 2B. In FIG. 2A a slit 210 is shown making it possible to separate a left side 215 from a right side 220 of the top ply or face ply 200. Instead of a slit 210, a gap of approximately ⅛ of an inch may be used to separate the left side 215 from the right side 220 on the top ply 200. A permanent or releasable adhesive (not specifically shown) may be behind the entire face ply 200 or cut back approximately 1/10 of an inch around the four sides of the document and/or cut back behind the slit 210 in the face stock 200 to prevent adhesive “ooze” which may cause laser, ink jet and thermal printers to fail.

Timing marks could also be press printed (not shown) to cue when the roll or fanfold documents are to be variably imaged and/or cut to size.

An RFID tag (not shown) could be sandwiched between the face ply 200 and liner ply 250 for control purposes.

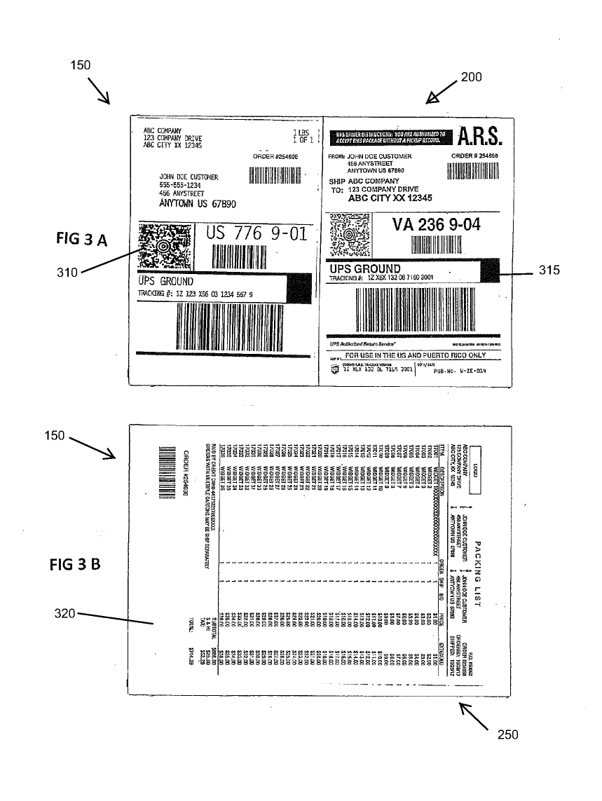

Turning to FIGS. 3A-3B, variable indicia is shown for both the top ply 200 and bottom ply 250 of the label 150. Parcel shipping data 310, 315 is shown on the top ply 200 in FIG. 3A and packing slip (box contents) data 320 is shown in FIG. 3B for the bottom ply 250. FIG. 3A shows an outbound label 310 and a Paid Return Label 315. The return label 315 could also be a Non Paid Return label. Typically a shipping label is called an outbound label e.g., as shown at 310, and a Return Label is called an inbound label e.g., as shown at 315. The order number could be printed in human readable characters in addition to a bar code on the two parcel labels 310, 315 and packing slip 320 for control purposes. The indicia 310, 315, 320 on both sides of the package assembly document can be read after the document is duplex imaged on both sides. The variable indicia 310, 315 may be printed on the top side of the top ply 200 and variable indicia 320 may be printed on the bottom surface of the bottom ply 250. As discussed herein, indicia may also be printed on the top surface (i.e., the surface comprising silicone) of the bottom ply 250.

The documents may be printed in a two-sided printer with the shipping label on the top side 200 and the packing slip on the bottom side 250, as shown in FIG. 3A-3B. Alternatively, the documents may be printed with the parcel label side facing down and the packing slip side facing up.

The size of a typical shipping label for parcel carriers such as UPS, FED EX and USPS is generally about 4×6 inches. The size of a typical inbound return parcel label is typically about 4×6 inches. These two labels combine for a size of roughly 8×6 inches for the Package Assembly Label shown in FIGS. 3A-3B, when the labels are positioned side-by-side. In this scenario, the packing slip 250 on the back side of this document is also about 8×6 inches, as shown in FIG. 3B. Alternatively, the labels may be positioned end-to-end, such that the Package Assembly Label is approximately 4×12 inches. In this scenario, the packing slip 250 on the back side of the document is also approximately 4×12 inches. Thus, the parcel side and packing slip side are extremely similar in size. It would be possible to re-arrange the format (not shown) to be in an “end to end” configuration. The 4×6 outbound label plus 4×6 return label would yield another size of about 4×12. In this end to end size the packing slip may be about 4×12 inches. The shipping label and the return label may also have other desirable and disparate dimensions.

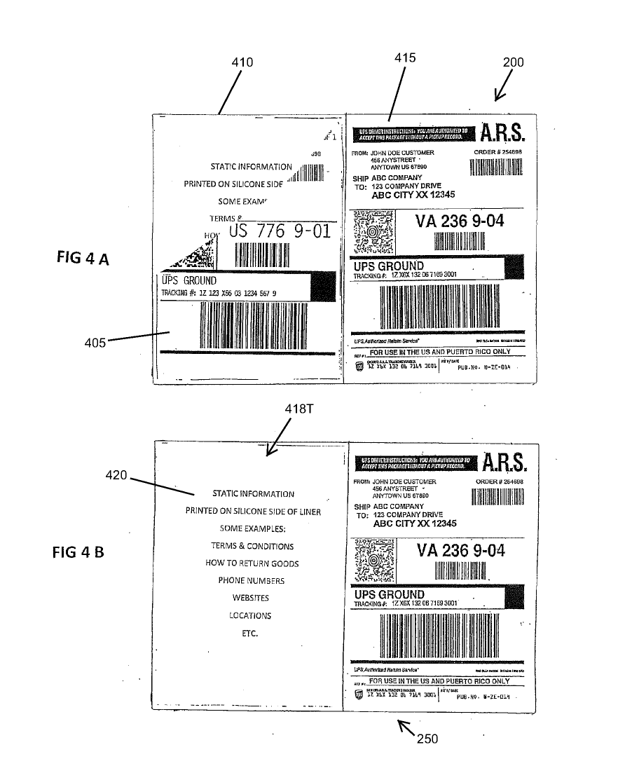

Turning now to FIGS. 4A-4B, FIG. 4A shows the outbound parcel shipping label 405 partially removed and then fully removed in FIG. 4B from the bottom ply 250. The packing slip or bottom side indicia are not shown in FIG. 4A-4B. Static (non-variable) information 420 may be press printed on the silicone side (i.e., the top surface) 418T of the bottom or liner ply 250. Static press printed information 420 could be, for example, Terms and Conditions, information regarding how to return goods, contact phone numbers, websites, locations, messages such as thank you for your business, et cetera.

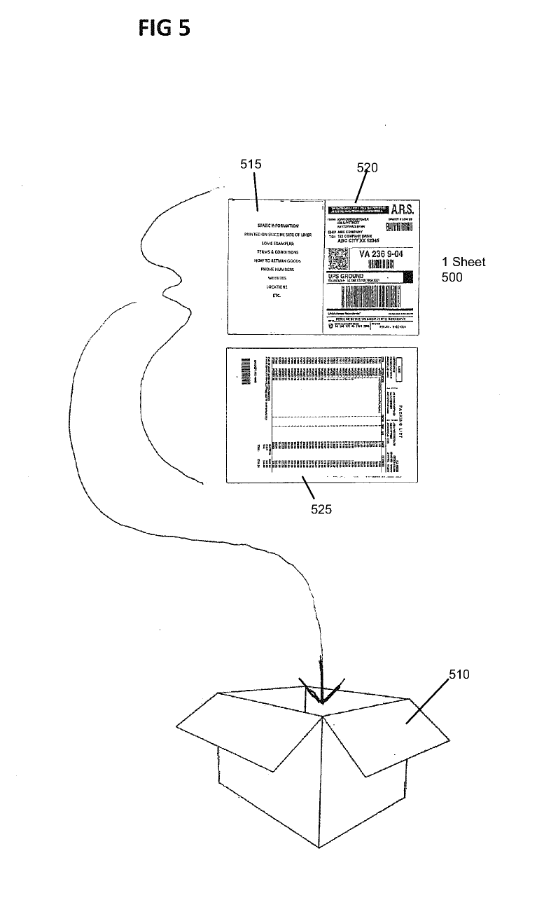

FIG. 5 shows the package assembly label 500 being dropped into an open box 510. Optional press printed static information 515 and a return label 520 the packing slip data 525 are visible. It is possible for this portion of the package assembly label to not be dropped into an open box as shown, but to instead be inserted into a PACKING LIST ENCLOSED plastic pouch (not shown) and affixed to the outside of the box or shipping container.

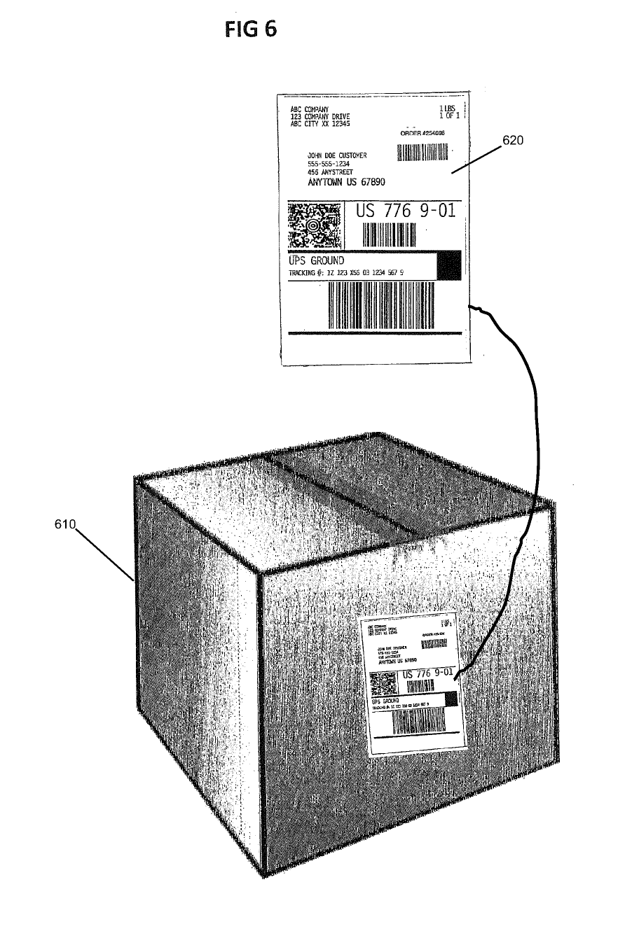

FIG. 6 shows the parcel shipping label 620 that was removed from the Package Assembly Document being affixed to a parcel shipping container or box 610. Note that the indicia could also include human readable order number characters and a bar code for a given order. The shipping label may be affixed to the top of the shipping box 610 or the side of the box 610.

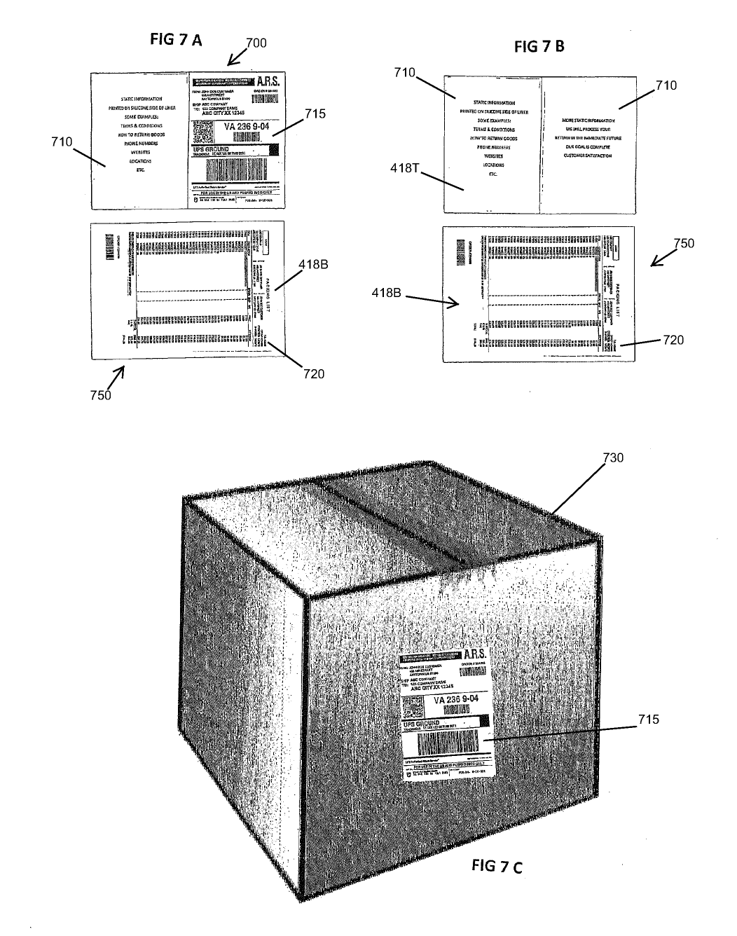

FIG. 7A shows a portion of the Package Assembly Document that may be delivered with the items ordered. It includes optional press printed static information 710, a return label 715, and packing slip data 720 (which is printed on the bottom surface 418B of the liner ply 750). If a recipient is happy with the goods purchased and delivered, no additional action is required. If, however, (an) item(s) need to be returned back to the sender, a pressure sensitive return label 715 can be removed from the bottom ply 750 and affixed to the outside of the carton 730. FIG. 7B shows the bottom ply 750 with additional optional press printed static information 710 printed on its top side 418T (which information 710 would now be visible) and the bottom ply 750 packing slip 720 on the bottom side 418B. FIG. 7C shows the pressure sensitive return label 715 affixed to the side of the box 730. The return label 715 may be affixed to any of the four sides or the top of the box. Preferably, the return label would go on top of the shipping label to avoid any confusion by the shipping company.

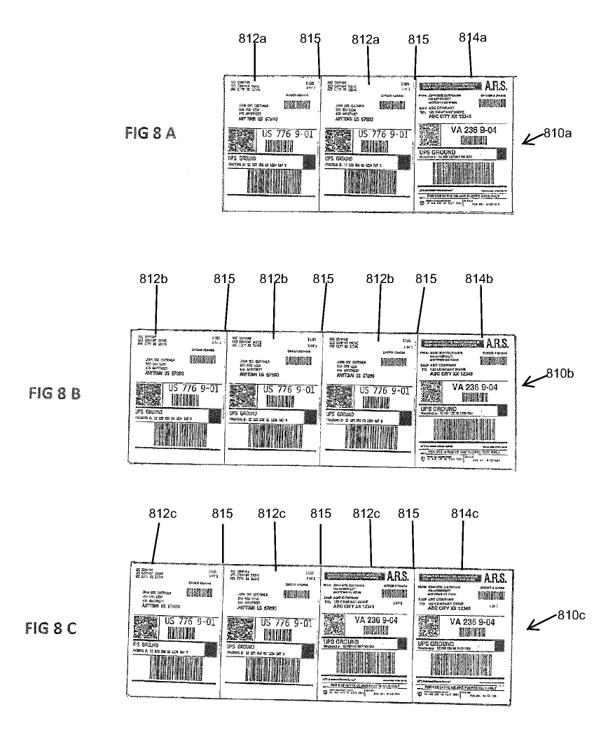

Turning to FIGS. 8A through 8C, 9A through 9C, and 10A through 10B, alternative embodiments of the present invention are depicted. For the sake of brevity, the remaining description will focus primarily on the differences of these alternative embodiments from the preferred embodiment described above.

In FIGS. 8A through 8C, top plies 810a, 810b, and 810c are respectively shown. There are additional slits or “gaps” 815 defining these sections in the top plies 810a, 810b, 810c. The document in FIG. 8 may accommodate orders requiring more than one outbound shipping container or box, and possibly more than one inbound or return box. Some packing slips may have too many SKUs to fit nicely into one box.

In FIGS. 8A-8C, a plurality of parcel labels 810a, 810b, 810c are shown for a specific order. FIG. 8A shows two outbound parcel labels 812a and one inbound parcel label 814a. FIG. 8B shows three outbound parcel labels 812b and one inbound parcel label 814b. FIG. 8C shows two outbound parcel labels 812c and two inbound parcel labels 814c. Five, six, seven, or any other number of parcel labels are possible. One packing slip or box contents document would be on the reverse side, but is not shown in FIGS. 8A-8C. A plurality of labels may be necessary because all of the items ordered may not fit into a single box and therefore may require two or more boxes. The size of the package assembly label for 8A may increase from about 6×8 inches (FIGS. 2 to 7) to about 6×12 inches in size. The size of the package assembly label for 8B may increase to about 6×16 inches in size. These approximate sizes are what were described in the side to side format. If they were formatted end to end, FIG. 8A would be approximately 4×18 inches or approximate package assembly size format for a specific order. Please note, parcel shipping companies like UPS, FED EX and USPS have unique shipping labels, unique human readable numbers and unique bar codes for each box. In this illustration, the bar codes and human readable numbers for the parcel carrier are all the same. Only box numbers such as “1 of 2” or “2 of 3” as examples, were changed in the illustration.

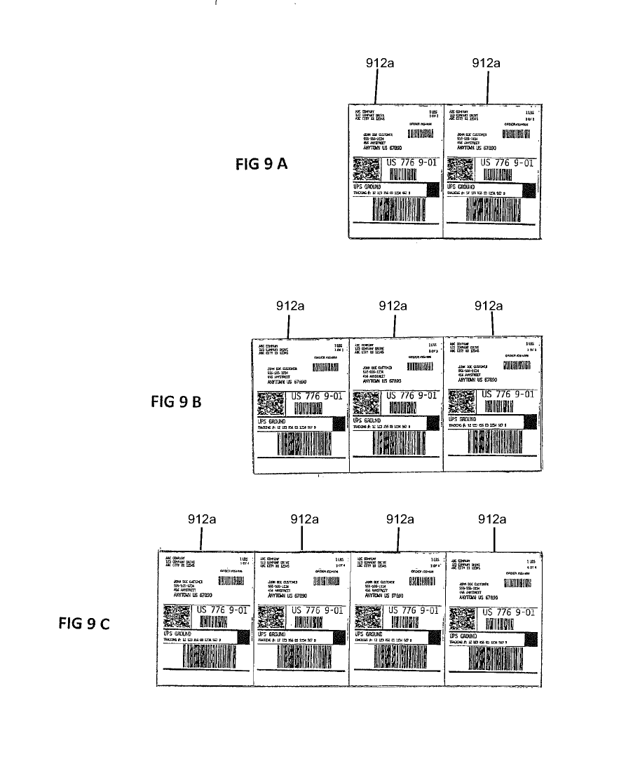

Another embodiment of the present invention may be constructed as shown in FIGS. 9A-9C, and may accommodate orders that require two or more outbound shipping labels for a given order, without the return label. FIG. 9A shows two outbound parcel labels 912a. FIG. 9B shows three outbound parcel labels 912a. FIG. 9C shows four outbound parcel labels 912a. Some companies do not supply a pressure sensitive return label to for easy returns. Sizes for side by side and end to end would follow the logic discussed above. Only box “x of y” was changed in FIG. 9 illustrations. All human readable numbers and bar codes, et cetera, would change box to box for the parcel carrier as each shipping label would have unique data.

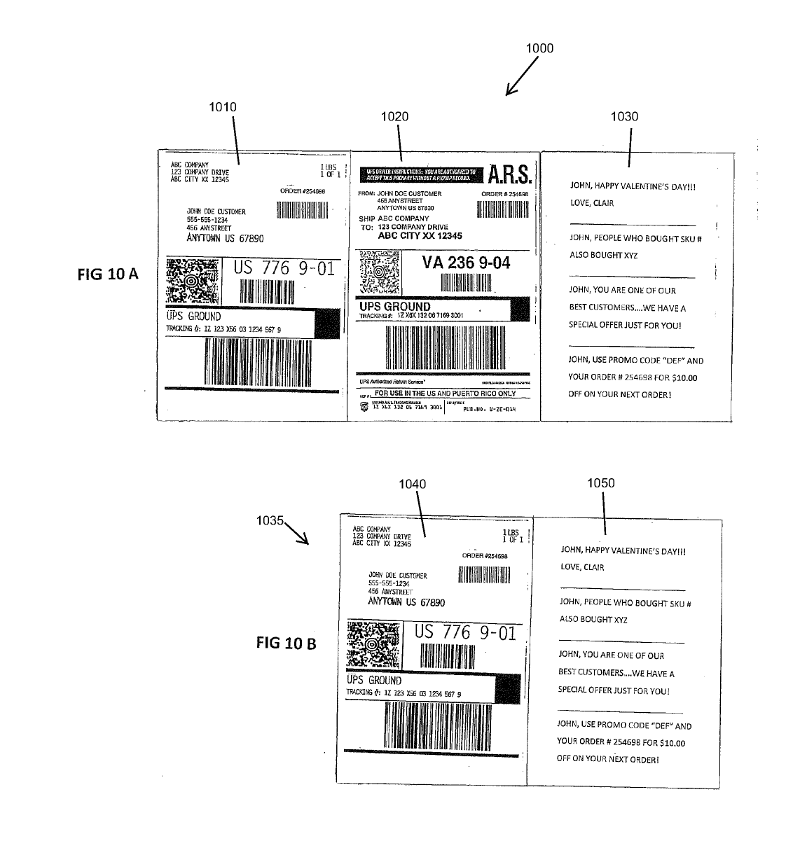

Another embodiment 1000 of the present invention is constructed as shown in FIG. 10A. Three top sections, i.e., an outbound parcel label 1010, an inbound parcel label 1020, and a section having variable personalized message indicia 1030, define the package document 1000. The personalized message could be in many forms, for example, (1) John, Happy Valentine's Day!!! Love, Clair, or (2) John, people who bought SKU # also bought XYZ, or (3) John, you are one of our best customers . . . we have a special offer just for you! or (4) John, use promo code “DEF” and your order # 254698 for $10.00 off on your next order! The personalized message indicia 1030 may also be also be presented on a personalized coupon (not shown). While not required, in some embodiments, the personalized coupon may be configured to be detachable from the assembly 1000 (e.g., by providing lines of weaknesses or perforations in the section having the variable personalized message indicia 1030).

Another embodiment 1035 of the present invention is constructed as shown in FIG. 10B. Two top sections (i.e., an outbound parcel label 1040 and a section having variable personalized message indicia 1050) define this embodiment 1035.

Many different arrangements of the various components depicted, as well as components not shown, are possible without departing from the spirit and scope of the present invention. Embodiments of the present invention have been described with the intent to be illustrative, rather than restrictive. Alternative embodiments will become apparent to those skilled in the art that do not depart from its scope. A skilled artisan may develop alternative means of implementing the aforementioned improvements without departing from the scope of the present invention. It will be understood that certain features and subcombinations are of utility and may be employed without reference to other features and subcombinations and are not contemplated within the scope of the claims. Various steps in described methods may be undertaken simultaneously or in other orders than specifically provided.

1. A package assembly document, comprising:
a top ply including a first shipping label and a first return label; and
a bottom ply having a top surface and a bottom surface; the top surface comprising silicone and being configured for releasable attachment of each of the first shipping label and the first return label; the bottom surface having indicia printed thereon; the indicia including a list outlining contents of a package to which the first shipping label is to be adhered to;
wherein the top ply includes a slit to separate the first shipping label from the first return label.

2. The package assembly document of claim 1, wherein the top ply further comprises a second shipping label.

3. The package assembly document of claim 2, wherein the second shipping label is separated from the first shipping label by a gap.

4. The package assembly document of claim 1, wherein the first shipping label includes a pressure sensitive adhesive for allowing said label to be adhered to the package.

5. The package assembly document of claim 4, wherein the first shipping label and the first return label are each generally rectangular.

6. The package assembly document of claim 5, wherein the first shipping label and the first return label have disparate dimensions.

7. The package assembly document of claim 1, wherein the top surface further comprises printed information that is exposed when the first return label is removed from the bottom ply.

8. The package assembly document of claim 1, wherein the top surface further comprises printed information that is exposed when the first shipping label is removed from the bottom ply.

9. A method of reducing waste associated with package assembly documents, the method comprising steps:
providing a package assembly document, comprising:
a top ply including a first shipping label and a first return label;
a bottom ply having a top surface and a bottom surface; the top surface comprising silicone and being configured for releasable attachment of each of the first shipping label and the first return label; and
printing a first indicia on the bottom surface; the first indicia including a list outlining contents of a package to which the first shipping label is to be adhered to.

10. The method of claim 9, further comprising the steps of printing a second indicia on the first shipping label and a third indicia on the first return label.

11. The method of claim 10, wherein each of the first indicia, the second indicia, and the third indicia are printed generally simultaneously.

12. The method of claim 11, wherein the first shipping label and the first return label are separated by a slit.

13. The method of claim 11, wherein the first shipping label and the first return label are separated by a gap.

14. The method of claim 13, wherein a width of the gap is generally ⅛^{th} of one inch.

15. The method of claim 9, further comprising the step of printing information on the top surface; the information being exposed when the first shipping label is removed from the bottom ply.

16. The method of claim 15, wherein the first indicia and the information are each printed using at least one of an inkjet printer, a laser printer, and a thermal printer.

17. A package assembly document, comprising:
a top ply including a shipping label and a return label; and
a bottom ply having a top surface and a bottom surface; the top surface comprising silicone and being configured for releasable attachment of each of the shipping label and the return label; the bottom surface having indicia printed thereon; the indicia including a list outlining contents of a package to which the first shipping label is to be adhered to;
wherein the top surface includes printed information that is exposed when the shipping label is removed from the bottom ply.

18. The package assembly document of claim 17, wherein the return label and the shipping label are separated by a gap.

19. The package assembly document of claim 18, wherein the top ply further comprises a second shipping label.

20. The package assembly document of claim 19, wherein the top ply further comprises a second return label.
